(19) United States
(12) Patent Application Publication
(10) Pub. No.: US 2011/0043843 A1
(43) Pub. Date: Feb. 24, 2011

(54) INFORMATION PROCESSING APPARATUS, METHOD FOR CONTROLLING INFORMATION PROCESSING APPARATUS, AND STORAGE MEDIUM

(75) Inventor: Kaori Nishiyama, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/850,177

(22) Filed: Aug. 4, 2010

(30) Foreign Application Priority Data
Aug. 19, 2009 (JP) 2009-189954

(51) Int. Cl. G06F 3/12

(52) U.S. Cl. 358/1.13

(57) ABSTRACT

An information processing apparatus according to the present invention can display necessary information in the order according to an identified user even if a display area for displaying information is limited. The information processing apparatus includes a display unit configured to display a plurality of messages, a storage unit configured to store priority order information for indicating a priority order of each of the plurality of messages to be displayed on the display unit by associating with each user, an identifying unit configured to identify a user, and a display control unit configured to control a display order of each of the plurality of messages to be displayed on the display unit according to the priority order indicated by the priority order information associated with the user identified by the identifying unit.

### BACKGROUND OF THE INVENTION

1. Field of the Invention

The present invention relates to an information processing apparatus, a method for controlling the information processing apparatus, and a storage medium.

2. Description of the Related Art

Some multifunctional information processing apparatuses (e.g., a multifunction peripheral having a copy function and a fax function) display statuses currently occurring in the information processing apparatus on an operation unit thereof (refer to Japanese Patent Application Laid-Open No. 2000-49996).

In this case, limitation of a display area may make it impossible to display all the statuses simultaneously, and the information processing apparatus may be configured such that a user can check all the statuses by operating a panel. When the information processing apparatus displays the statuses and if the display area is limited as described above, the following two problems arise.

A first problem lies in a notification method when a plurality of events occurs. In the currently known art, only a message having the highest priority is displayed to prioritize a display of the message that is most required to be notified to the user. In this method, however, the user cannot recognize other events having a lower priority.

A second problem lies in a message notification method to a user currently operating the information processing apparatus. In the conventional art, since the same messages are displayed in a status line in the same manner for all users, the messages remain displayed even when they are unnecessary to the user currently operating the apparatus. Therefore, a login user cannot easily view necessary messages due to the display of the messages unnecessary to him/herself.

### SUMMARY OF THE INVENTION

According to an aspect of the present invention, an information processing apparatus includes a display unit configured to display a plurality of messages, a storage unit configured to store priority order information for indicating a priority order of each of the plurality of messages to be displayed on the display unit by associating with each user, an identifying unit configured to identify a user, and a display control unit configured to control a display order of each of the plurality of messages to be displayed on the display unit according to the priority order indicated by the priority order information associated with the user identified by the identifying unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an image forming apparatus according to an exemplary embodiment of the present invention.

FIG. 2 is a plain view illustrating an example of a configuration of an operation unit.

FIG. 3 schematically illustrates an example of a standard screen displayed on a liquid crystal operation unit.

FIG. 4 schematically illustrates an example of a setting screen displayed on the liquid crystal operation unit.

FIGS. 5A to 5C illustrate display control tables managed by the image forming apparatus.

FIG. 6 is a flowchart illustrating a control procedure executed by the image forming apparatus.

### DESCRIPTION OF THE EMBODIMENTS

Various exemplary embodiments, features, and aspects of the invention will be described in detail below with reference to the drawings.

### <Description of System Configuration>

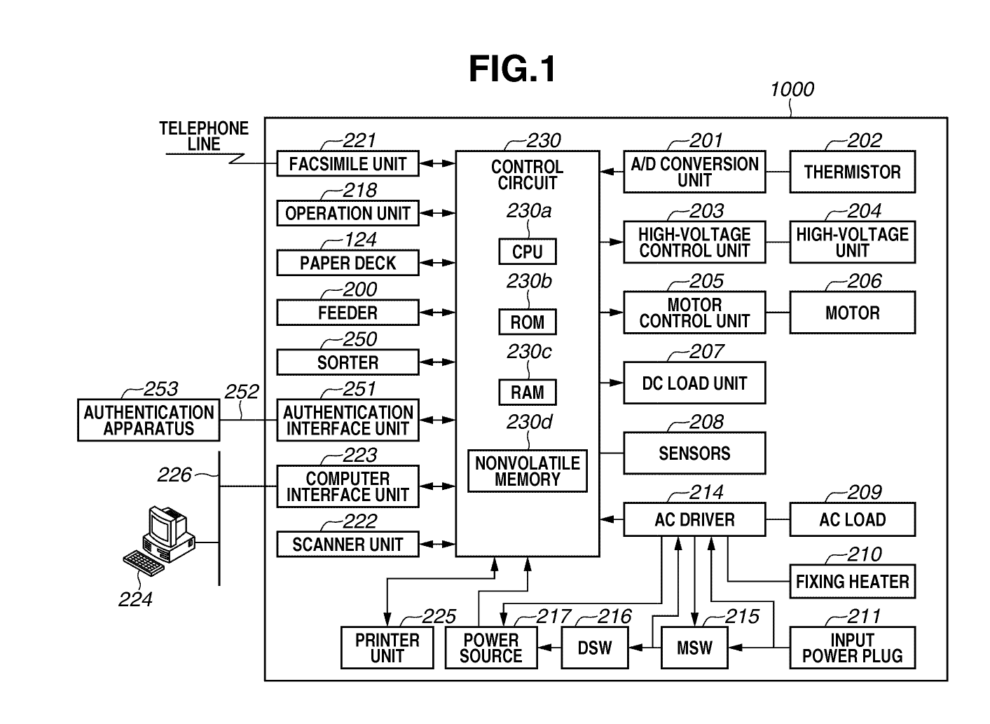

FIG. 1 is a block diagram illustrating an image forming apparatus according to a first exemplary embodiment of the present invention. In the present exemplary embodiment, the information processing apparatus is described using an image forming apparatus of a multifunction peripheral (MFP) type as example, but the present invention is not limited thereto. Therefore, the present invention can be applied to an image forming apparatus of a single function peripheral (SFP) type. Further, the image forming apparatus in the present exemplary embodiment has a limited display area for displaying a status currently occurring in the image forming apparatus. For example, a status is indicated by a message consisting of one line in a lower area of an operation screen.

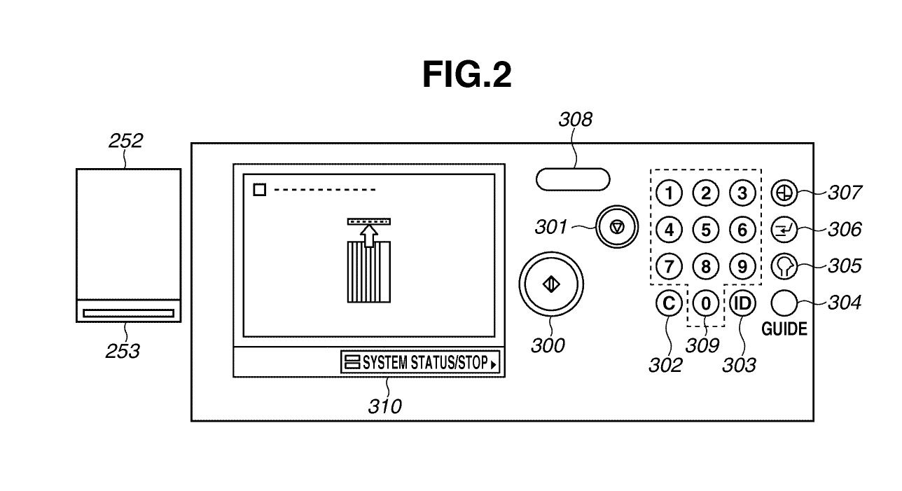

Referring to FIG. 1, an image forming apparatus main body 1000 includes a control circuit (hereinafter referred to as “controller”) 230 which controls each of units required for image forming processing. The controller 230 includes a central processing unit (CPU) 230a, a read-only memory (ROM) 230b, a random access memory (RAM) 230c, a non-volatile memory 230d, and the like. The CPU 230a provides an overall control of a copy sequence by running a control program stored in the ROM 230b. The RAM 230c is used as, for example, a work area of the CPU 230a. The non-volatile memory 230d may include, for example, a hard disk, a flash memory, an electrically erasable programmable read-only memory (EEPROM), and an erasable programmable read-only memory (EPROM), and stores programs and data required for a screen display and language switching at an operation unit. An operation unit 218 includes keys for setting a copy mode (for example, one-sided copy/two-sided copy/multiplex copy, copy ratio, and paper cassette selection), a numeric keypad for setting a copy quantity or the like, and a start key for instructing a copy operation start. Further, the operation unit 218 includes key input units such as a stop key for instructing a copy operation stop and a reset key for returning an operation mode to a standard status, and a display unit such as a light emitting diode (LED) or liquid crystal for displaying, for example, setting conditions of the operation mode. The details of the operation unit 218 will be described below with reference to FIG. 2.

An analog/digital (A/D) conversion unit 201 converts an analog signal indicating a surface temperature of a fixing roller 151 detected by a thermistor 202 to a digital signal, and inputs the converted digital value to the controller 230. The controller 230 controls the surface temperature of the fixing roller 151 to become a predetermined value based on the detection value of the thermistor 202. A high-voltage control unit 203 controls a high-voltage unit 204 which applies predetermined electric potential to a charging system and a development unit.

A motor control unit 205 controls driving of motors such as various stepping motors, and a main driving motor. A direct current (DC) load control unit 307 controls driving of, for example, a solenoid of a pickup roller, a clutch of a registration roller, and a fan (not-shown). Sensors 208 include various sensors for use in, for example, detection of a paper jam of a transfer sheet. Detection results of the sensors are input to the controller 230.

An alternating current (AC) driver 214 controls AC power supply to an AC load 209 and a fixing heater 210, and detects abnormality of the fixing heater 210 or the like to thereby turn off a main switch (MSW) 215 which has a shutoff function.

Further, under the control of the controller 230, AC input is switched before and after the main switch 215, and is input to a power source 217. The power source 217 supplies DC power to the controller 230 or the like. AC power is input from the AC driver 214, and AC power is also input from an input power plug 211 via the main switch (MSW) 215 and a door switch (DSW) 216.

A paper deck 124 is a paper feeding device which is provided to increase the number of stored transfer sheets. A feeder 200 is an automatic document feeding device with which a plurality of documents can be automatically set. A sorter 250 is a sorting device which sorts discharged transfer sheets.

A facsimile unit 221 decompresses compressed image data received via a telephone line and then transfers the decompressed image data to the controller 230, or compresses image data transferred from the controller 230 and then transmits the compressed image data via the telephone line.

The compressed image data received by the facsimile unit 221 can be temporarily stored in the non-volatile memory 230d. An authentication interface unit 251 communicates with an authentication apparatus 253 via an exclusive line 252 to exchange user information, and causes the controller 230 to perform control of login and logout of a user.

A scanner unit 222 reads an image on a document, generates image data, ant transmits the image data to the controller 230. A printer unit 225 prints an image onto a sheet based on the image data transmitted from the controller 230.

A computer interface unit 223 establishes a connection via a network 226 with an information processing apparatus 224 which is a personal computer or a work station (PC/WS). The CPU 230a receives information such as code data indicating an image (image data, and page description language (PDL) data), and unit price setting transferred from the information processing apparatus 224, and stores them in the non-volatile memory 230d.

The information processing apparatus 224 includes a display unit for displaying various kinds of information, a keyboard and a pointing device for receiving an input from a user, a CPU, a RAM, a ROM, a network interface, and the like, although they are not particularly shown in FIG. 1.

### <Description of an Operation Unit>

FIG. 2 is a plane view illustrating an example of a configuration of the operation unit 218 shown in FIG. 1. Referring to FIG. 2, a start key 300 is pressed down when a user starts copying and facsimile transmission. A stop key 301 is pressed down when the user stops (cancels, interrupts) copying and facsimile transmission. A clear key 302 is pressed down when the user deletes an input value. An ID key 303 is pressed down to cancel an authenticated state.

A guide key 304 is pressed down when the user needs explanations of respective functions of, for example, the image forming apparatus 1000, the feeder 200, and the sorter 250. An operator memory key 305 is pressed down when the user sets specifications and statuses of the image forming apparatus 1000, the feeder 200, and the sorter 250, or the like. An operator mode includes a function setting with which the user can assign a desired function to a key (two options), a specification setting, a timer setting, and an adjustment/cleaning setting.

An interrupt key 306 is pressed down when the user wants to interrupt the current copy job and start another copy job. A pre-heat key 307 is pressed down when a user wants the image forming apparatus 1000 to enter a pre-heat mode which can reduce power consumption, or when the user wants to return the image forming apparatus 1000 from the pre-heat mode to a normal mode.

A reset key 308 is pressed down when the user wants to reset the current copy mode to a standard copy mode. By pressing the reset key 308 for a while, an audio guidance mode can be started and stopped. A numeric key pad 309 is used for an input of a numerical value such as a copy ratio setting and an input of a number of copies.

A liquid crystal operation unit 310 is constituted by a touch panel display, and displays, for example, the statuses of the image forming apparatus 1000, the feeder 200, and the sorter 250, and setting conditions of the copy mode. A touch on a soft key displayed on the touch panel display can change/shift a screen displayed thereon to another screen, so that the user can perform settings of the copy mode or the like.

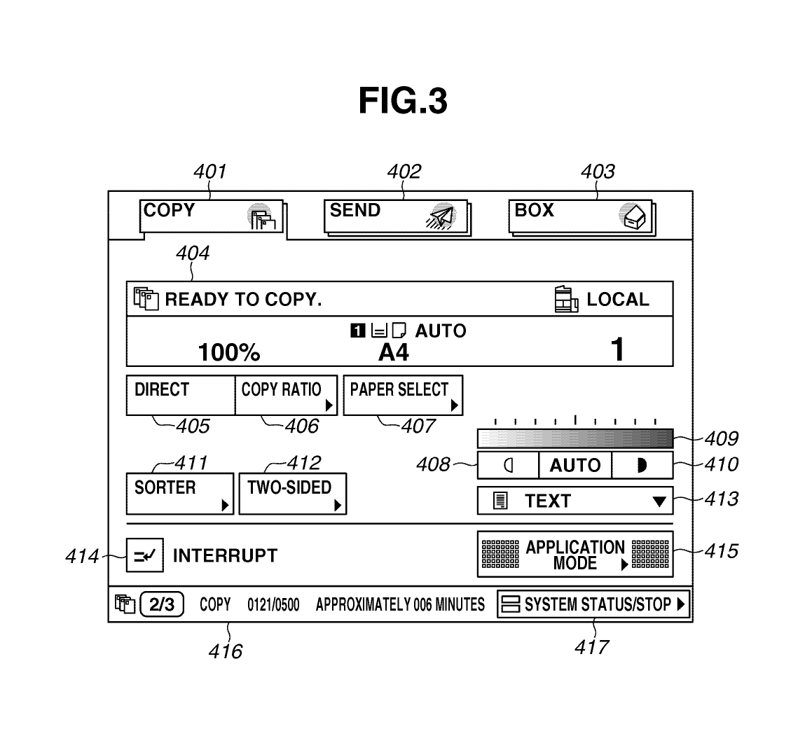

The authentication apparatus 253 is connected to the main body 1000 via the exclusive line 252. FIG. 2 illustrates the liquid crystal operation unit 310 which displays a screen before a user is authenticated by the authentication apparatus 253. When the user inserts his/her card into the authentication apparatus 253 and is successfully authenticated, a standard screen shown in FIG. 3 appears.

### <Standard Screen>

FIG. 3 schematically illustrates an example of the standard screen displayed on the liquid crystal operation unit 310 shown in FIG. 2.

Referring FIG. 3, in an upper section of the liquid crystal operation unit 310, there are displayed buttons for each of a plurality of functions, such as a copy key 401, a send key 402, and a box key 403. The screen shown in FIG. 3 is an initial screen of the copy function which appears when the copy key 401 is pressed down.

In a status display column 404, there are displayed such as the statuses of the copy apparatus, a reversing document feeder (RDF), and the sorter 250, a set copy quantity per document, a set copy ratio, and a specified sheet size. A direct key 405 is pressed down when copying is performed at the same size as a size of an original document.

A copy ratio key 406 is pressed down when an output size of a copy is reduced/enlarged than the size of the original document. A paper select key 407 is pressed down to select a size and type of a sheet, and a paper feeding position.

Density keys 408, 409, and 410 are used to adjust a copy density. The light key 408 or the dark key 410 is pressed down to manually adjust the copy density. The auto key 409 is pressed down when the user selects or cancels an auto density adjustment function.

A sorter key 411 is pressed down when the user sets how the sorter 250 outputs printed sheets (e.g., non-sort, sort, and group sort), and a staple position. A two-sided key 412 is pressed down when the user wants to make a two-sided copy from one-sided or two-sided documents or a book document, or to make one-sided copies from a two-sided document.

An image quality key 413 is pressed down to select an image quality (e.g., document includes text only, text and photo, and photo only) to make a copy. An interrupt key 414 is pressed down when the user wants to interrupt the current copy job and start another copy job.

An application mode key 415 is pressed down to use various functions of the copy apparatus. A status line 416 is an area for displaying the status of the image forming apparatus 1000. This area displays an alarm message such as a paper jam, and a status message indicating an execution of PDL printing when PDL printing is currently being performed. The screen shown in FIG. 3 displays the status of the copy job being currently executed (the number of output sheets and the duration time).

A system status/stop key 417 is pressed down when the user wants to view a screen displaying the device information about the image forming apparatus 1000 and a print job status, to change the order of jobs, and to stop a job. When the send key 402 is pressed, the image forming apparatus 1000 displays a setting screen via which the user can send the read image data by e-mail or file transfer protocol (FTP) to an apparatus connected to the network 226, or send fax image data with use of the telephone line.

When the box key 403 is pressed, the image forming apparatus 1000 displays a setting screen via which the user can store the image data read by the scanner unit 222 in a box area in the hard disk of the non-volatile memory 320d, or a setting screen via which the user can print the image data stored in the box area or send the image data stored in the box area to an apparatus connected to the network 226.

### <Method for Registering Priority Order and Display/Non-Display Setting>

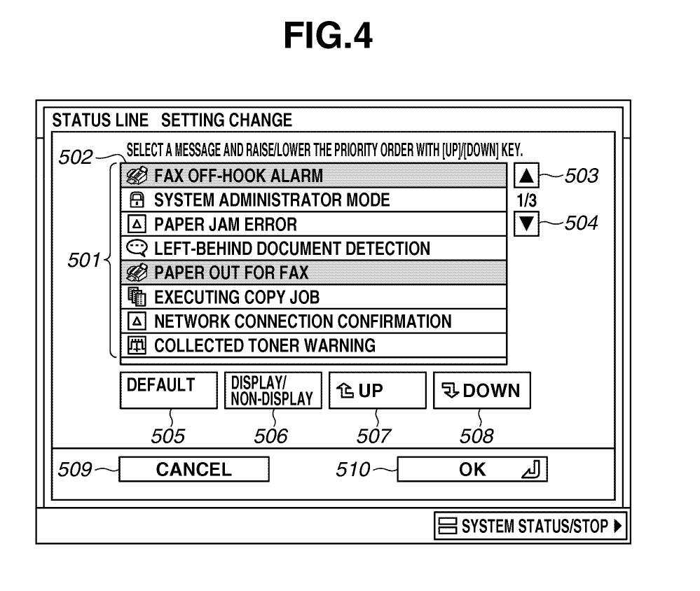

Now, a description will be given of how each user changes a priority order and non-display/display setting of a status (message) to be displayed in the status line 416, with reference to FIG. 4. FIG. 4 schematically illustrates an example of a setting screen displayed on the liquid crystal operation unit 310 shown in FIG. 2. The CPU 230a causes the liquid crystal operation unit 310 to display the setting screen after performing the login processing for identifying a user. Alternatively, the CPU 230a may cause the liquid crystal operation unit 310 to display the setting screen in response to that the user presses down the operator memory key 305 and performs a predetermined operation.

Referring to FIG. 4, a section 501 displays messages to be displayed in the status line 416 and the priority order thereof. The messages are sorted in descending order of the priority for being displayed in the status line 416. Icons 502 indicate categories which the respective messages belong to.

Page shift keys 503 and 504 are used to view the previous or next page. A default key 505 is used to return the priority order setting and the display/non-display setting to the default values. A display/non-display switching button 506 enables a user to arbitrary select a message that is unnecessary to be displayed for the user to not display.

FIG. 4 indicates that the message “PAPER OUT FOR FAX” displayed in the section 501 is currently set as a “non-display” message. For changing the current setting so that the message “PAPER OUT FOR FAX” will be displayed in the status line 416, the user selects the item corresponding to the message “PAPER OUT FOR FAX” and then presses down the display/non-display switching button 506.

An up key 507 is pressed down to raise the display priority order of the currently selected message. A down key 508 is pressed down to lower the display priority order of the currently selected message. A cancel button 509 is pressed down to return the currently selected settings to the settings before this setting screen is displayed. An OK button 510 is pressed to apply the currently selected settings.

In this way, information set by the user is stored and managed in the non-volatile memory 230d along with the user identification information.

### <Status Line Display Method>

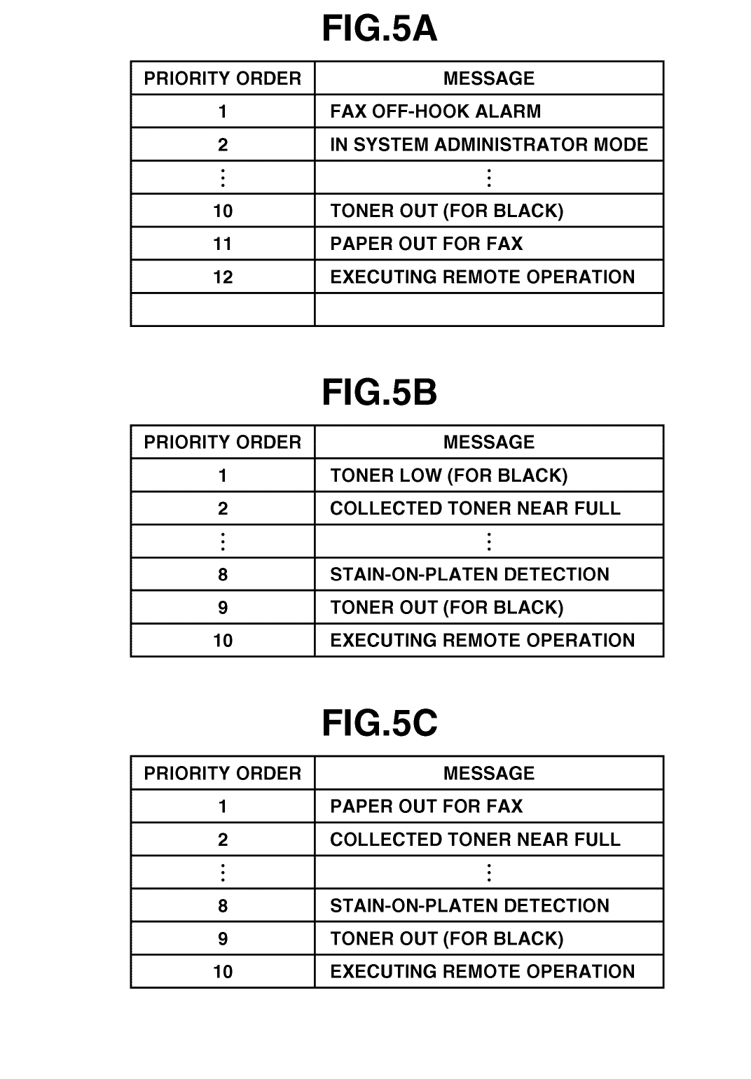

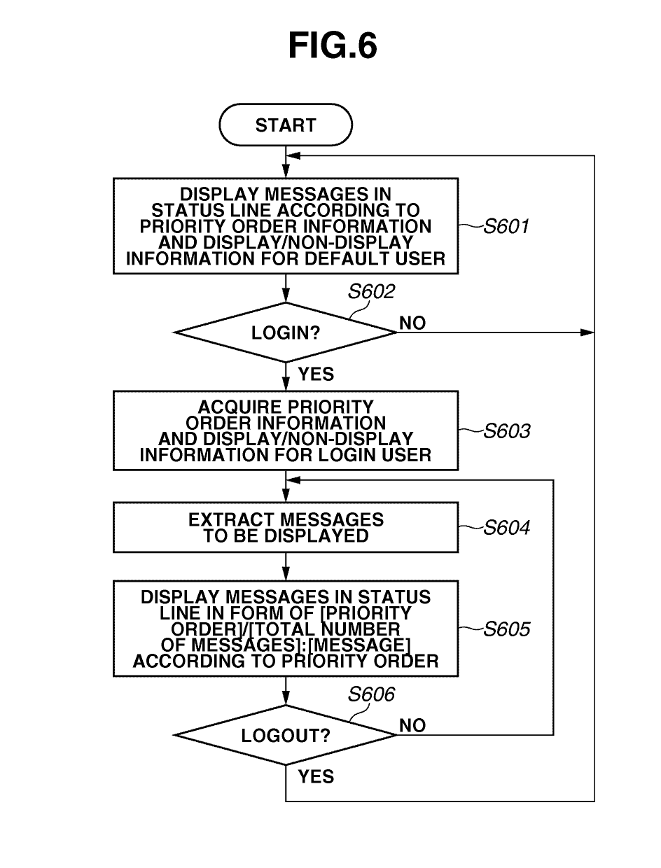

Next, a display control of the status line 416 will be described below with reference to FIGS. 5A to 5C and FIG. 6.

FIGS. 5A to 5C illustrate display control tables managed by the image forming apparatus 1000 shown in FIG. 1. In these display control tables, the priority order is set to each of the messages that the user wants to display in the status line 416. A message set as the “non-display” message is not listed in the display control table, so that the message will not be displayed in the status line 416.

FIG. 5A illustrates the display control table for a default user. FIG. 5B illustrates the display control table for a user A. FIG. 5C illustrates the display control table for a user B.

The CPU 230a performs control for switching messages displayed in the status line 416 of the operation unit 218 among the display based on FIG. 5A, the display based on FIG. 5B, and the display based on FIG. 5C, by performing a procedure illustrated in the flow chart which will be described below. The table shown in FIG. 5A corresponds to “status line priority order information and display/non-display information” for the default user. The tables shown in FIGS. 5B and 5C correspond to “status line priority order information and display/non-display information” for login users.

FIG. 6 is a flowchart illustrating an example of a control procedure executed in the image forming apparatus 1000 according to the present exemplary embodiment. This example corresponds to a status line display control procedure. Each of steps S601 to S606 in the flowchart is realized by the CPU 230a loading a control program read out from the ROM 230d to the RAM 230c and executing it.

In step S601, since the image forming apparatus 100 is in a state before a user logs therein, i.e., in a state that nobody logs in the image forming apparatus 1000 currently, the CPU 230a displays the messages in the status line 416 based on “the status line priority order information and display/non-display information” for the default user. At this time, the CPU 230a compares events currently occurring in the image forming apparatus 1000 with “the status line priority order information and display/non-display information” for the default user, and extracts all of the messages to be displayed. Then, the CPU 230a sequentially displays the extracted messages in the status line 416 according to the priority order shown in FIG. 5A. In the present exemplary embodiment, the CPU 230a displays a message along with a total number of a plurality of messages to be displayed and the priority order of the currently displayed message, according to a display format of the status line ([priority order]/[total number of messages] [message] in the present exemplary embodiment). Accordingly, the total number of the currently occurring events among the events (statuses of the image forming apparatus 1000) that the user wants to be displayed, and the priority order of the currently notified events are notified the user all together, so that the user can more easily understand the status of the image forming apparatus 1000. When messages are sequentially displayed according to the priority order thereof, the CPU 230a switches a display of each message included in the plurality of messages at a predetermined time interval. More specifically, the CPU 230a deletes the message that has been displayed until now, and displays a new message at the predetermined time interval.

Next, in step S602, the CPU 230a determines whether a user operates the operation unit 218 and logs in the image forming apparatus 1000. At this time, the CPU 230a makes a determination based on whether a card is inserted in the authentication apparatus 253 and is successfully authenticated. If the CPU 230a determines that nobody logs in the image forming apparatus 1000 (NO in step S602), the processing returns to step S601. In step S601, the CPU 230a displays messages in the status line 416 based on “the status line priority order information and display/non-display information” for the default user.

On the other hand, if the CPU 230a determines in step S602 that the user logs in the image forming apparatus 1000 (YES in step S602), the processing proceeds to step S603. In step S603, the CPU 230a acquires “the status line priority order information and display/non-display information” for the user (login user) identified at the login processing from the non-volatile memory 230d.

Then, in step S604, the CPU 230a compares the events currently occurring in the image forming apparatus 1000 with “the status line priority order information and display/non-display information” for the login user, and extracts all of the messages to be displayed. If a message corresponding to the event currently occurring in the image forming apparatus 1000 is not listed in “the status line priority order information and display/non-display information” for the login user, that message is not selected as a message to be displayed.

Then, in step S605, the CPU 230a sequentially displays the messages extracted in step S604 in the status line 416 according to the priority order of the messages indicated by “the status line priority order information and display/non-display information” for the login user. At this time, the CPU 230a also displays the priority order of the currently displayed message and the total number of the messages extracted in step S604. For example, assumes a case that the login user is the user B, a black toner has run out, paper for fax has run out, and a remote operation is currently executed at the image forming apparatus 1000. In this case, according to the table shown in FIG. 5C, the CPU 230a sequentially displays “1/3 PAPER OUT FOR FAX”, “2/3 TONER OUT (FOR BLACK)”, and “3/3 EXECUTING REMOTE OPERATION” in this order. If the user B has set the message “EXECUTING REMOTE OPERATION” as the non-display message, the CPU 230a displays the messages “1/2 PAPER OUT FOR FAX”, and “2/2 TONER OUT (FOR BLACK)”.

In step S606, the CPU 230a determines whether the login user logs out from the image forming apparatus 1000. If the user logs out from the image forming apparatus 1000 (YES in step S606), the processing returns to step S601. If the user does not log out from the image forming apparatus 1000 (NO in step S606), the CPU 230a checks the events currently occurring in the image forming apparatus 1000 again, and extracts all of the messages to be displayed.

In this way, the CPU 230a sequentially displays messages according to the priority order indicated by the table shown in FIG. 5B or 5C after a registered user logs in the image forming apparatus 1000.

The CPU 230a displays messages in the display order based on “the status line priority order information and display/non-display information” for the login user, until the user logs out from the image forming apparatus 1000 by pressing down the ID key 303 shown in FIG. 2.

In the above described exemplary embodiment, immediately after the CPU 230a identifies the login user in step S602, the CPU 230a displays most appropriate messages for the login user. However, after the login user is identified, the CPU 230a may perform control to display high priority messages for the user upon detection that the user operates a specific button on the operation panel.

Further, in the above described exemplary embodiment, the display control table does not contain the messages for which the “non-display” setting is selected. However, a flag indicating the “non-display” setting may be set to each of such messages in the table. In this case, in step S604 in FIG. 6, the CPU 230a checks the flag of each message, and does not extract messages to which the “non-display” flag is set.

Further, in the above described exemplary embodiment, when the CPU 230a displays the messages associated with the user, each message is displayed for the same length of time. However, the time lengths for displaying the respective messages may be registered in the table in association with the priority order. Alternatively, the time lengths for displaying the respective messages may be set by a user and registered according to the user's setting. In these cases, the login user may control the image forming apparatus 1000 to display the next message every time display time set to each message has passed.

Further, as the table shown in FIG. 5A, the CPU 230a may use a table corresponding to a specified date and time, and a specified day of the week according to a usage environment of the user. In this case, the paper-out status and the toner-out status can be quickly recognized by preferentially prompting a toner check and a paper check to a normal user on a specified date or a specified day of the week when the copy quantity is expected to be increased depending on a work type.

Further, the above described exemplary embodiment may be employed in an image forming apparatus which manages permitted functions or prohibited functions for each user as user authority information, and determines which functions a user can use or cannot use according to the managed authority information. In this case, the image forming apparatus determines messages to be displayed in the liquid crystal operation unit 310 according to the user authority information. For example, when a user logs in the image forming apparatus, the CPU 230a of the image forming apparatus checks the authority information of the login user, and determines which functions the login user can use or cannot use from among a plurality of functions of the image forming apparatus. Then, the CPU 230a sequentially displays the messages associated with the functions permitted to the login user in the liquid crystal operation unit 310 in the order of priority, and performs control such that the messages associated with the functions prohibited to the login user are not displayed. Accordingly, the user can more quickly check the messages associated with the functions permitted to the user. Alternatively, the CPU 230a may display the messages associated with the functions prohibited to a user after displaying the messages associated with the functions permitted to the user, instead of performing the control such that the messages associated with the functions prohibited to the user are not displayed.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-189954 filed Aug. 19, 2009, which is hereby incorporated by reference herein in its entirety.

What is claimed is:

1. An information processing apparatus, comprising:
a display unit configured to display a plurality of messages;
a storage unit configured to store priority order information for indicating a priority order of each of the plurality of messages to be displayed on the display unit by associating with each user;
an identifying unit configured to identify a user; and
a display control unit configured to control a display order of each of the plurality of messages to be displayed on the display unit according to the priority order indicated by the priority order information associated with the user identified by the identifying unit.

2. The information processing apparatus according to claim 1, wherein the display control unit causes the display unit to sequentially display the plurality of messages starting from a message of the plurality of messages having the highest priority order.

3. The information processing apparatus according to claim 1,
wherein, when the identifying unit identifies the user, the display control unit causes the display unit to display the plurality of messages in the display order according to the priority order indicated by the priority order information associated with the identified user, instead of a display order set in advance to the plurality of messages to be displayed at the display unit.

4. The information processing apparatus according to claim 1, wherein the display control unit displays a total number of the plurality of messages to be displayed and a priority order of a currently displayed message.

5. A control method for controlling an information processing apparatus which comprises a display unit for displaying a plurality of messages, the method comprising:
identifying a user;
obtaining priority order information associated with the identified user from a storage unit which stores the priority order information for indicating a priority order of each of the plurality of messages to be displayed on the display unit by associating with each user; and
controlling a display order of each of the plurality of messages to be displayed on the display unit according to the priority order indicated by the obtained priority order information.

6. A computer-readable storage medium for storing computer-executable instructions for controlling an information processing apparatus which comprises a display unit for displaying a plurality of messages, the computer-executable instructions comprising:
instructions for identifying a user;
instructions for obtaining priority order information associated with the identified user from a storage unit which stores the priority order information for indicating a priority order of each of the plurality of messages to be displayed on the display unit by associating with each user; and
instructions for controlling a display order of each message to be displayed on the display unit according to the priority order indicated by the obtained priority order information.

7. An information processing apparatus, comprising:
a display unit configured to display a plurality of messages;
a storage unit configured to store priority order information for indicating a priority order of each of the plurality of messages to be displayed on the display unit; and
a display control unit configured to control the display unit to display each of messages occurring in the information processing apparatus and a total number of the messages occurring in the information processing apparatus.
